(19) United States
(12) Patent Application Publication
(10) Pub. No.: US 2006/0159950 A1
(43) Pub. Date: Jul. 20, 2006

(54) Sputtering target, dielectric film formed from the sputtering target and method for producing the dielectric film

(76) Inventors: Terufusa Kunisada, Tokyo (JP); Etsuo Ogino, Tokyo (JP); Masahiro Ikadai, Tokyo (JP)

Correspondence Address: WHITHAM, CURTIS & CHRISTOPFFERSON, P.C.;SUITE 340, 11491 SUNSET HILLS ROAD, P.O. BOX 9204, RESTON, VA, 20190, US

(21) Appl. No.: 11/302,472

(22) Filed: Dec. 14, 2005

(30) Foreign Application Priority Data
Jan. 17, 2005 (JP) P2005-008572

(51) Int. Cl. B32B 9/00

(52) U.S. Cl. 428/689; 204/298.13; 204/192.15

(57) ABSTRACT

A sputtering target according to the invention including an oxide sintered body containing NbOₓ and TiOₓ in which the abundance ratio of Ti atoms in the target is from 70% to 90% both inclusively. Preferably, the oxide sintered body has a specific resistance value not higher than 10Ω·cm. Preferably, theoxidesinteredbody has a thermal expansion coefficient not larger than 7 ×10⁻⁶/K and a thermal conductivity not lower than 10 ×10⁻⁴ cal/mm-K-sec.

### BACKGROUND OF THE INVENTION

1. Field of the Invention

The present invention relates to a sputtering target used in a sputtering technique for forming a dielectric film chiefly used in the field of optical technology. Particularly it relates to a composite oxide target material for forming a dielectric optical thin film having a high refractive index.

2. Related Art

Optical thin films are used widely in display devices such as liquid crystal display elements, optical parts for optical communication, optical disks and various. kinds of products such as building window glass, automobile windshield, etc.

In an optical multilayer film which is a laminate of these optical thin films, thin films with a high refractive index are used in combination with thin films with a low refractive index so that an optical interference effect can be used. From this fact, a transparent material having a high refractive index is very important.

An oxide dielectric material such as TiO₂, Ta₂O₅, Nb₂O₅, ZrO₂, HfO₂, etc. is known as the transparent material having a high refractive index and is used widely.

A wet film forming method or an in-vacuum physical film forming method is used as a method for forming a thin film from these materials. When the number of films to be laminated is large or when it is necessary to control the film thickness with high accuracy, the in-vacuum physical film forming method is preferred.

Various methods such as vacuum vapor deposition, ion plating, sputtering, etc. can be used as this type physical film forming methods. When films need to be formed on a large substrate for display device or building window material, sputtering is the most suitable method.

The method for forming an oxide thin film with a high refractive index by a sputtering technique can be roughly classified into two kinds of techniques. One is a technique (reactive sputtering technique) using a metal target such as Ti, Ta, Nb, Zr, Hf, etc. for forming an oxide film in the presence of an oxygen-containing gas used as a sputtering gas. The other is a technique using an oxide of a metal such as Ti, Ta, Nb, Zr, Hf, etc. as a target for forming an oxide thin film by sputtering in an atmosphere of a gas having a low oxygen content.

The former film forming technique has a problem that the film forming speed is low, and has a problem that discharge becomes unstable because the surface of the target is covered with an electrically insulating oxide in a sputtering process to thereby cause arcing.

Various methods using an oxide sintered body as a target have been heretofore proposed as measures to solve these problems (e.g. Japanese Patent Publications Nos. JP 2004-2202A, JP 2001-58871A, JP 2002-338354A and JP H08-283935A). JP 2004-2202A or JP 2001-58871A has disclosed a method using an oxide sintered body mainly containing TiOₓ as a target. JP 2002-338354A or JP H08-283935A has disclosed a.method using an oxide sintered body mainly containing NbOₓ as a target. Because these proposals aim at providing an oxide target to be applied to DC discharge, these proposals relate to a production method for giving electrical conducting characteristic to the target.

When the oxide target material has no electrical conducting characteristic, there is known a method of applying a high-frequency voltage to the target to perform sputtering. This method is limited in the case where the size of the target is small. As the size of the target increases, uniform discharge cannot be kept because of the relation between the wavelength of the high-frequency voltage and the size of the target to thereby make it substantially difficult to form a film. It is therefore necessary to perform DC discharge for forming a filmwitha large area. From this point of view, it is an important requirement that the target material has electrical conducting characteristic.

When a DC bias is applied to a TiOₓ target in an argon gas atmosphere to form a film having a high refractive index, there is however a problem that a film defect is formed because dust generated by fine destruction of a surface of the target is deposited on the surface of the substrate. It is conceived that such destruction of the target surface is caused by heating of the target surface due to discharge at the time of sputtering.

The thin film obtained with use of the aforementioned target, however, has a sufficient utility value for a high refractive index non-absorbent thin film in terms of optical constants because the refractive index of the thin film is 2.40 at a wavelength of 632.8 nm. It is however impossible to use the thin film industriallybecausethethinfilmhasalotof drawbacks. It is difficult to use the thin film particularly in the field of display devices requiring high film quality.

Next, when a DC bias is applied to an NbOₓ target in an argon gas atmosphere to form a thin film having a high refractive index, the aforementioned destruction of the target surface due to discharge at the time of sputtering is not observed so that a defect-free film can be obtained. It has been however found that it is difficult to use the film as an optical thin film because the refractive index is as high as 2.2 (wavelength: 632.8 nm) but optically absorbent when optical constants of the film are measured.

That is, when a heretofore knownoxide sintered body material is used as a sputtering target, there arises either the problem of film defects caused by fine destruction of the target surface or the problem of optical absorbance.

Although a measure to mix oxygen in a sputtering gas atmosphere may be conceived as a method for reducing the optical absorbance of the film, mixing of oxygen causes arcing to thereby induce a problem that discharge becomes unstable. If an oxygen-containing gas is used as a sputtering gas for forming a high refractive index film on a resin, the resin surface may be ashed to cause an additional problem that adhesion of the film to the resin is lowered. For this reason, an ideal oxide sintered body material is a film which is transparent and non-absorbent in spite of sputtering film formation in an oxygen-free sputtering gas atmosphere.

### SUMMARY OF THE INVENTION

The invention is achieved to solve the problem. An object of the invention is to provide a sputtering target including an oxide sintered body containing TiOₓand NbOₓ, in which an optical thin film few in film defects and low in optical absorbance can be formed by a sputtering technique.

The invention provides a sputtering target including an oxide sintered body having a composition represented by TiₓNb_{y}O_{z} (in which x, y and z are positive numbers respectively), wherein: the abundance ratio of Ti atoms in the target is from 70% to 90% both inclusively; and the oxidation degree of the constituent material of the target is from 90% to 99% both inclusively.

When an oxide sintered body formed of such a material is used as a target, the aforementioned destruction of the target surface due to discharge at the time of sputtering is not observed even in the case where a DC bias is applied for performing sputtering in an atmosphere containing no oxygen or a small amount of oxygen. As a result, a high refractive index optical thin film few in defects and low in optical absorbance can be obtained.

Preferably, the oxide sintered body used as a sputtering target has a specific resistance value not higher than 10Ω·cm. Although the target having a composition excessive in metal has electrically conducting characteristic from the point of view of the stoichiometric ratio of oxide, stable DC sputtering can be made to form a large-area film when the specific resistance of the target is reduced.

Preferably, the oxide sintered body has a thermal expansion coefficient not larger than 7×10⁻⁶/K and a thermal conductivity not lower than 10×10⁻⁴ cal/mm K sec. When the composition of the target or the oxidation degree of the target is adjusted so that the oxide sintered body has the physical properties as described above, destruction of the target surface due to thermal stress can be suppressed remarkably.

When a material having a small thermal expansion coefficient is used, stress generated in the target surface can be reduced. When a material having a high thermal conductivity is used as a target, temperature rise of the target surface can be suppressed. Accordingly, thermal stress can be restrained from being caused by heating of the target surface, so that there arises an effect in preventing destruction of the target surface.

The invention also provides a dielectric film formed by a sputtering technique with use of a sputtering target defined above. When such a target is used, a dielectric film few in defects and low in optical absorbance can be obtained, so that a high refractive index optical thin film of good quality can be provided. The composition of such a thin film is substantially the same as that of the target material, so that the abundance ratio of Ti atoms in the film is from 75% to 85% both inclusively.

The invention further provides a method of producing a dielectric film, including the step of forming a thin film by a sputtering technique with use of a sputtering target defined above, wherein the concentration of oxygen contained in a sputtering gas is not higher than 2%. By this condition, stable film formation can be made, so that a high refractive index optical thin film few in defects and low in optical absorbance can be provided. In addition, an optical thin film formed on a resin can be provided.

When a sputtering target according to the invention is used for forming a film by a sputtering technique, a transparent dielectric film few in film defects and extremely low in optical absorbance can be obtained, so that an optical thin film having a high refractive index can be provided.

### BRIEF DESCRIPTION OF THE DRAWINGS

FIG. 1 is a graph showing the relation between the composition ratio of a target and stress;

FIG. 2 is a graph showing the relation between the composition ratio of a target and the defect density of a film; and

FIG. 3 is a graph showing the relation between the composition ratio of a target and coefficients of thermal conductivity and thermal expansion.

### DETAILED DESCRIPTION OF THE PREFERRED EMBODIMENTS

The invention is based on the inventors' finding that fine destruction of a surface of a target mainly containing TiOₓ is caused by thermal stress during sputtering film formation. Although thermal stress generated in the target surface varies in accordance with physical properties of the target material such as thermal conductivity, thermal expansion coefficient, Yong's modulus, specific heat, etc., it mainly depends on the two physical properties of thermal expansion coefficient and thermal conductivity.

Therefore, sintered bodies were produced while the mixture ratio of TiOₓ to NbOₓ in the material was changed. TiOₓ mentioned here is an oxide of excessive Ti represented by 1<x<2 compared with TiO₂. Similarly, NbOₓ is an oxide of excessive Nb represented by 2<x<2.5 compared with Nb₂O₅. The thermal conductivity and thermal expansion coefficient of the produced sintered body were measured by a laser flash method and with a thermomechanical analyzer, respectively.

The value of stress generated in the target surface was calculated on the basis of these measured values. The absolute value of stress is easily influenced by other factors such as the cooling efficiency of the target, the shape and size of the target, etc. than the physical properties of the target material. Therefore, the shape and size of the target and the cooling condition were fixed so that a tendency toward change in stress in accordance with the composition of the target material was evaluated.

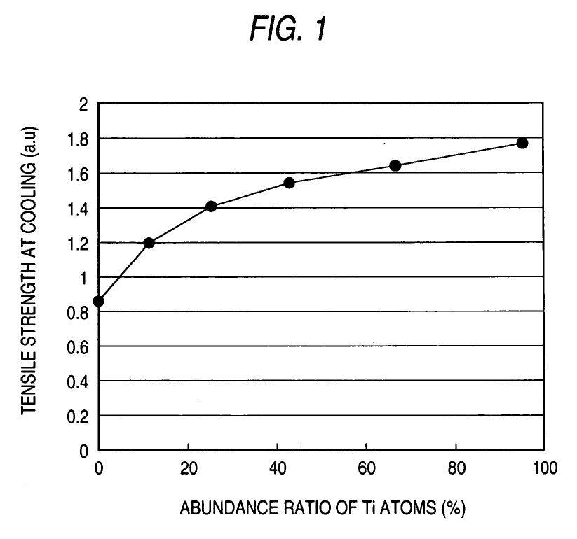

FIG. 1 shows a result of the calculation. It was found from the calculation result that tensile stress at cooling decreases remarkably as the abundance ratio of Ti atoms in the target decreases. Incidentally, the abundance ratio of Ti atoms is defined by the following expression.
Abundance Ratio of Ti Atoms (%) ={(Number of Ti Atoms/(Number of Ti Atoms +Number of Nb Atoms)}×100

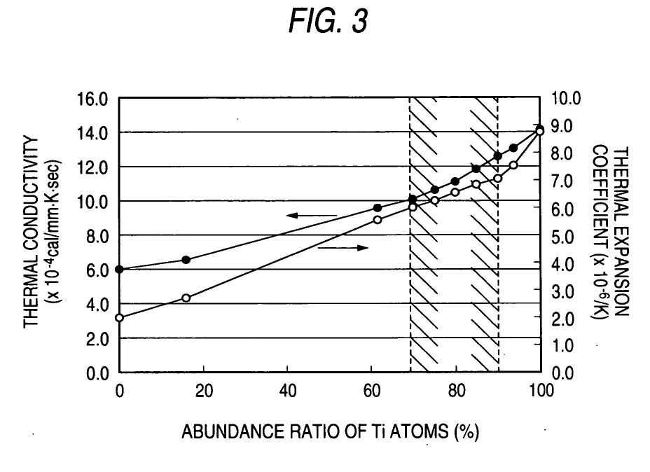

It can be estimated that reduction in stress is remarkable particularly when the abundance ratio of Ti atoms is not higher than 35%. As will be described later with reference to FIG. 3, the thermal expansion coefficient increases as the TiOₓ content increases, and the thermal conductivity also increases as the TiOₓ content increases. Stress increases as the thermal expansion coefficient increase, that is, as the TiOₓ content increases. On the other hand, high thermal conductivity is preferred in order to suppress the temperature rise of the target surface to thereby reduce stress caused by the temperature change. It can be conceived that stress change having an inflection point with respect to the Ti content as shown in FIG. 1 occurs in view of the two.

It was also found that a transparent film having no optical absorbance can be formed even in the case where formation of the film is performed by sputtering in an oxygen-free argon gas atmosphere when the abundance ratio of Ti atoms is from 70% to 90% both inclusively. The magnitude of absorbance depends on the abundance ratio of Ti atoms, so that absorbance decreases as the amount of Ti increases. This result is caused by the fact that Ti has a high affinity for oxygen. It can be estimated that a large part of oxygen released from the target into a space is recombined with Ti in the sputtering process.

It was also confirmed that the refractive index of the film is sufficiently high so that the film can be used as an optical thin filmwitha high refractive index. On the other hand, the magnitude of absorbance largely depends on the oxygen content of the target. That is, it is important to adjust the oxygen content of the target. That is, it is important to decide the ratio x:y:z in the composition TiₓN_{b}yO_{z}.

The oxidation degree indicating the percentage of oxidation of Ti and Nb constituting the target is given by the following expression:
Oxidation degree (%)=X/(Xt+Xn)×100
in which X is the weight of the target, Xt is the weight (calculated in terms of the weight of TiO₂) of the product when Ti contained in the target is oxidized perfectly, and Xn is the weight (calculated in terms of the weight of Nb₂O₅) of the product when Nb contained in the target is oxidized perfectly.

The mode for carrying out the invention will be described below in detail.

The sputtering target was produced as follows. A mixture of high-purity TiO₂ power and high-purity Nb₂O₅ power available on the market was heated in a temperature range of from 1100° C. to 1400° C. in an argon gas atmosphere so as to be subjected to hot press. The mixture ratio was changed in a range of from the case where only TiO₂ was contained to the case where only Nb₂O₅ was contained. Thus, ten kinds of targets in total were produced as shown in Table 1. The sintered body of each mixture ratio obtained thus was cut into a shape (5 inches×6 inches) and polished to obtain a sputtering target with a thickness of 5 mm. Each target had electrically conducting characteristic and had a specific resistance value not higher than 10Ω·cm.

The method of evaluating the oxidation degree is as follows. First, the weight (X) of the target as a subject is measured. The molar ratios of Ti and Nb contained in the unit weight of the target are measured. Xt and Xn are calculated on the basis of the molar ratios of Ti and Nb.

The molar ratio of Ti and the molar ratio of Nb were evaluated by an inductively coupled plasma measuring method. The procedure using the inductively coupled plasma emission spectral analysis method for measuring the molar ratios of Ti and Nb contained in the unit weight of the target is as follows.

The target material was ground in a mortar to form powder. The powder was dried at 100° C. for an hour. Then, sodium carbonate and boric acid were added into the target material powder and mixed with the target material powder in a platinum dish. The resulting mixture was heated with a burner so as to be melted. Then, the melt was cooled and dissolved in hydrochloric acid. The resulting solution was diluted to a suitable concentration. The diluted solution was subjected to inductively coupled plasma emission spectral analysis. Thus, the molar ratio of Ti and the molar ratio of Nb can be measured.

Then, the weight Xt of oxide in the case where all the measured Ti was in the form of TiO₂ and the weight Xn of oxide in the case where all the measured Nb was in the form of Nb₂O₅ were calculated. The oxidation degree can be calculated on the basis of the values of Xt and Xn. The oxidation degree of the material in which the abundance ratio of Ti atoms was not lower than 70% was from 90to 99%. The material had a relatively high oxidation degree.

The target was mounted in a sputtering apparatus. A DC voltage was applied to the target in an argon gas atmosphere to perform sputtering film formation. Oxygen may be mixed with the sputtering gas in order to adjust the composition of the film to be formed. Incidentally, when oxygen is mixed, there is however a problem that electric discharge becomes unstable because of occurrence of arcing. In addition, when a film is formed on a resin, there is a problem that the resin surface is ashed. It is therefore preferable that the oxygen content is selected to be not higher than 2%.

Table 1 shows a result of evaluation of each of the obtained films.

The abundance ratio of Ti atoms in the dielectric film formed with use of each target was evaluated. Evaluation was made in the same manner as the evaluation of the target except that the film on the substrate was dissolved in acid. As a result, when the abundance ratio of Ti atoms in the target was from 75% to 85%, the abundance ratio of Ti atoms in the film was also from 75% to 85%. It was found that a dielectric film having a composition substantially equal to the composition of the target is formed.

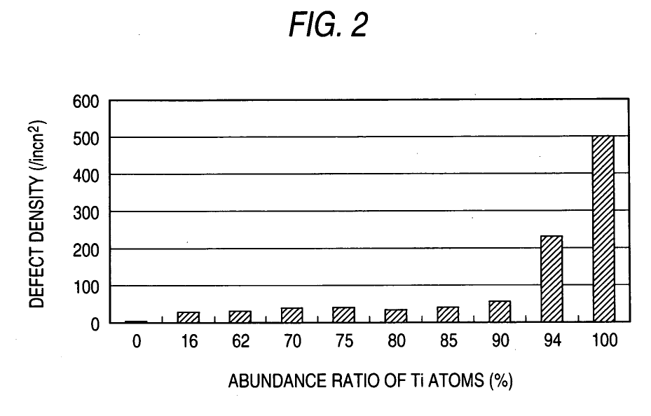

The defect density of the dielectric film formed with use of each target was counted by eye observation with use of a high-luminance halogen lamp in a dark room. Consequently, as shown in FIG. 2, the defect density increased rapidly when the abundance ratio of Ti atoms exceeded 90%. When the abundance ratio of Ti atoms was not higher than 90%, the defect density was not higher than about 100 per square inch (=6.26 cm²) and a very good film quality was obtained.

The optical characteristic of each film was measured with an ellipsometer. The refractive index at a wavelength of 632.8 nm was in a range of from 2.35 to 2.20. In any case, this was such a range in which the film was regarded as a high refractive index material. When a Ti-free NbOₓ target was used, the extinction coefficient became 0.01 or greater so that optical absorbance occurred (as represented by X in Table 1) It is apparent that a transparent film having no optical absorbance can be obtained when the abundance ratio of Ti atoms is not lower than 70%, preferably not lower than 75%.

As shown in FIG. 3, the thermal expansion coefficient increases as the TiOₓ content increases. The thermal expansion coefficient is in a range of from 6.0×10⁻⁶/K to 7.0×10⁻⁶/K. As shown in FIG. 3, the thermal conductivity also increases as the TiOₓ content increases. It is apparent that the thermal conductivity is in a range of from 10.0×10⁻⁴ cal/mm-K-sec to 12.5×10⁻⁴ cal/mm-K-sec.

Considering the aforementioned result, the range of the composition of the target in which a film low in defect density and low in optical absorbance can be obtained is in that the abundance ratio of Ti atoms is from 70% to 90% both inclusively, preferably from 75% to 85% both inclusively. Preferably, the oxide sintered body has a thermal expansion coefficient not larger than 7×10⁻⁶/K and a thermal conductivity not lower than 10.0×10⁻⁴ cal/mm-K- sec. More preferably, it can be said that the oxide sintered body has a thermal expansion coefficient not larger than 6.5×10⁻⁶/ K and a thermal conductivity not lower than 11×10⁻⁴ cal/mm-K-sec.

TABLE 1

| Abundance | | Refractive | | Thermal | Thermal | |
|---|---|---|---|---|---|---|
| ratio of | Defect | index | | conductivity | expansion | Oxidation |
| Ti atoms | density | (wavelength: | | (×10⁻⁴ | coefficient | degree |
| (%) | (/inch²) | 632.8 nm) | Absorbance | cal/mm · K · sec ) | (×10⁻⁶/K) | (%) |
| 0 | 3 | 2.20 | X | 6.0 | 2.0 | 85 |
| 16 | 30 | 2.35 | X | 6.6 | 2.7 | 88 |
| 62 | 30 | 2.30 | X | 9.5 | 5.5 | 90 |
| 70 | 40 | 2.30 | ◯ | 10.0 | 6.0 | 95 |
| 75 | 40 | 2.35 | ◯ | 10.7 | 6.2 | 97 |
| 80 | 35 | 2.35 | ◯ | 11.0 | 6.5 | 94 |
| 85 | 40 | 2.35 | ◯ | 11.8 | 6.8 | 96 |
| 90 | 55 | 2.35 | ◯ | 12.5 | 7.0 | 96 |
| 94 | 230 | 2.40 | ◯ | 13.0 | 7.5 | 96 |
| 100 | 500 | 2.40 | ◯ | 14.0 | 8.7 | 95 |

What is claimed is:

1. A sputtering target comprising an oxide sintered body having a composition represented by TiₓNb_{y}O_{z} in which x, y and z are positive numbers respectively, wherein an abundance ratio of Ti atoms in the target is from 70% to 90% both inclusively; and an oxidation degree of a constituent material of the target is from 90% to 99% both inclusively.

2. A sputtering target according to claim 1, wherein the abundance ratio of Ti atoms in the target is from 75% to 85% both inclusively.

3. A sputtering target according to claim 1, wherein the oxide sintered body has a specific resistance value not higher than 10 Ω·cm.

4. A sputtering target according to claim 1, wherein the oxide sintered body has a thermal expansion coefficient not larger than 7×10⁻⁶/K and a thermal conductivity not lower than 10×10⁻⁴ cal/mm-K-sec.

5. A dielectric film formed by a sputtering technique with use of a sputtering target defined in claim 1.

6. A dielectric film according to claim 5, wherein the abundance ratio of Ti atoms in the film is from 75% to 85% both inclusively.

7. A method of producing a dielectric film, comprising the step of forming a thin film by a sputtering technique with use of a sputtering target defined in claim 1, wherein a concentration of oxygen contained in a sputtering gas is not higher than 2%.
